(19) United States
(12) Patent Application Publication
(10) Pub. No.: US 2012/0019158 A1
(43) Pub. Date: Jan. 26, 2012

(54) Polarity-reversible dimming controller having function of switching light source

(75) Inventors: Chung-Shu Lee, Wugu Township (TW); Shih-Chang Lee, Wugu Township (TW); Chih-Kuan Lin, Wugu Township (TW); Chao-Ching Hsu, Wugu Township (TW)

(73) Assignee: Chiccony Power Technology Co., Ltd.

(21) Appl. No.: 12/804,493

(22) Filed: Jul. 22, 2010

(51) Int. Cl. H05B 37/02

(52) U.S. Cl. 315/224

(57) ABSTRACT

A polarity-reversible dimming controller having function of switching light source has a power supply module and a dimming control module. The dimming control module receives an external PWM dimming signal to control a feedback signal of the power supply module so as to dim or power on/off an LED lamp. The dimming control module has an output current switching circuit, a switch control circuit and a dimming control circuit. The output current switching circuit performs a PWM control over a current outputted from the power supply module by using the external PWM dimming signal to maintain chromacity of the LED lamp as a constant. The switch control circuit turns off the PWM controller to enter a standby mode for saving power once the PWM dimming signal exceeds a threshold value. As a full-wave rectification is performed on the PWM dimming signal, the polarity match issue upon assembling can be disregarded.

### BACKGROUND OF THE INVENTION

1. Field of the Invention

The present invention is related to a dimming controller for LED lamp, and more particularly to a dimming controller not affecting chromacity and aiding an external dimming controller to directly control a light source.

2. Description of the Related Art

Using the pulse width modulation (PWM) to perform dimming control of LED lamps is a well-known technique. Regularly, a PWM dimming control system has a dimming controller and a PWM dimmer serving as a dimming switch. The dimming controller has a power supply unit and a dimming control unit. The power supply unit has a PWM controller for controlling the duty cycle of a lamp. An input terminal of the dimming control unit is connected with the PWM dimmer. An output terminal of the dimming control unit is connected with a feedback terminal of the PWM controller. The dimming control unit receives a PWM dimming signal from the PWM dimmer to vary a feedback signal of the PWM controller, thereby achieving to dim the LED lamp.

It is known that dimming LED lamps need to vary an output current of the power supply unit. With reference to FIG. 3, a characteristics curve is disclosed in association with forward voltages Vf and forward currents If of a LED lamp. A region where the forward currents If linearly vary with the forward voltage Vf is a dimming operation region. It means that the forward current If varies in proportion to the forward voltage Vf and the varied forward current If also adjust the luminance of the LED lamp while chromacity of the LED lamp is also changed. Usually, a lower value of chromacity pertains to a red yellowish color (warm color) while higher value of chromaticty pertains to a blue greenish color (cold color). Such change of chromacity causes discomfort to people with visual sensitivity. For certain special applications, chromaticity plays an important role. If LED lamps are subjected to apparent change of chromaticty for sake of current variation, applications of the LED lamps are definitely limited. Accordingly, how to dim LED lamps without varying chromacity thereof is an issue to be tackled.

Moreover, to meet the dimming requirement of LED lamps, the dimming controller must be remained to be operating regardless of if the LED lamps are used, meaning that the dimming controller still consumes power when the LED lamps are not operating. Such unnecessary energy waste needs to be improved.

Assembling conventional PWM dimming control system becomes inconvenient because the positive and negative polarities of external PWM dimmer can not be incorrectly connected. To ensure the correctness of the polarities, additional check needs to be performed inevitably. However, reverse connection of the polarities of the PWM dimmer still happen and make the PWM dimmer fail to function. Hence, the polarity matching issue also needs to be solved.

### SUMMARY OF THE INVENTION

An objective of the present invention is to provide a polarity-reversible dimming controller having function of switching light source, not affecting chromacity and aiding an external dimming controller to directly control a light source.

To achieve the foregoing objective, the polarity-reversible dimming controller has a power supply module and a dimming control module.

The power supply module is adapted to connect with an AC power source and control a duty cycle of the AC power source to supply power and has an and has an output terminal, a ground terminal and a PWM controller. The PWM controller has a feedback terminal. The dimming control module controls a signal and an output current of the feedback terminal of the PWM controller and has a full-wave rectifier, an output current switching circuit, and a dimming control circuit.

The full-wave rectifier has an input terminal and an output terminal. The output terminal is connected to the output current switching circuit and the dimming control circuit.

The output current switching circuit has a first switch and a second switch. The first switch is a transistor and has a gate connected to the output terminal of the full-wave rectifier. The second switch is a transistor and has a gate, a source and a drain. The gate is connected to the drain of the first switch. The source is connected to the ground terminal of the power supply module. The drain is connected to the output terminal of the power supply module.

The dimming control circuit is connected with the feedback terminal of the PWM controller.

The dimming control module receives an external PWM dimming signal to control a feedback signal of the power supply module so as to dim or power on or off an LED lamp. Meanwhile, the output current switching circuit performs a PWM control over a current outputted from the power supply module by using the external PWM dimming signal to uniformly maintain chromacity of the LED lamp. As a full-wave rectification is performed on the PWM dimming signal by the full-wave rectifier, the polarity match issue upon assembling the dimming controller can be disregarded.

### BRIEF DESCRIPTION OF THE DRAWINGS

FIGS. 1A to 1G are detailed circuit diagrams of a polarity-reversible dimming controller having function of switching light source in accordance with the present invention;

FIG. 2 is an operating waveform diagram of an output current switching circuit in accordance with the present invention; and

FIG. 3 is characteristics curve associated with currents and voltages of a LED lamp.

### DETAILED DESCRIPTION OF THE INVENTION

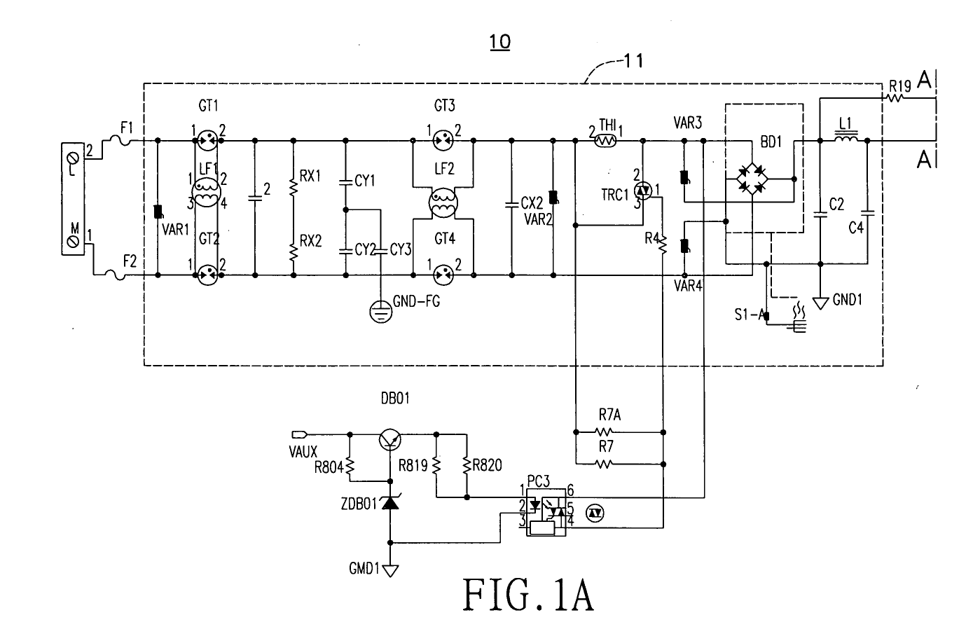

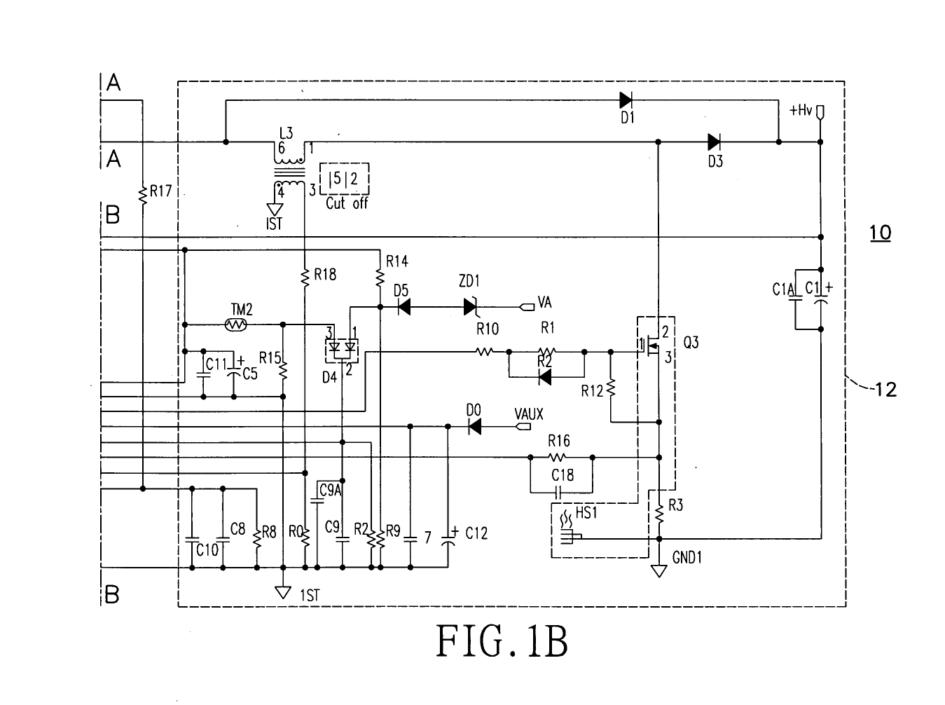

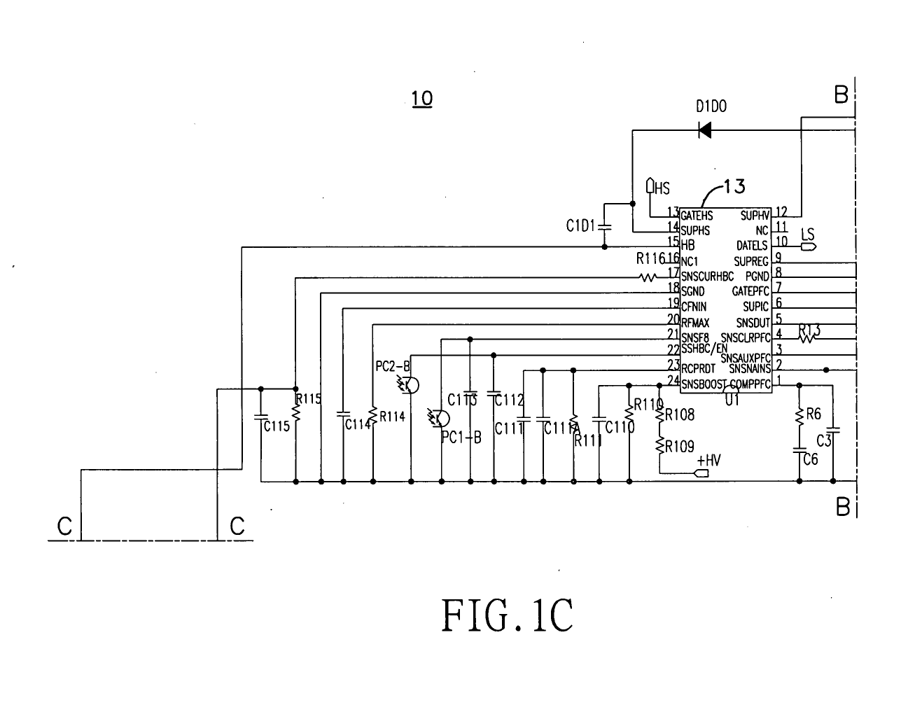

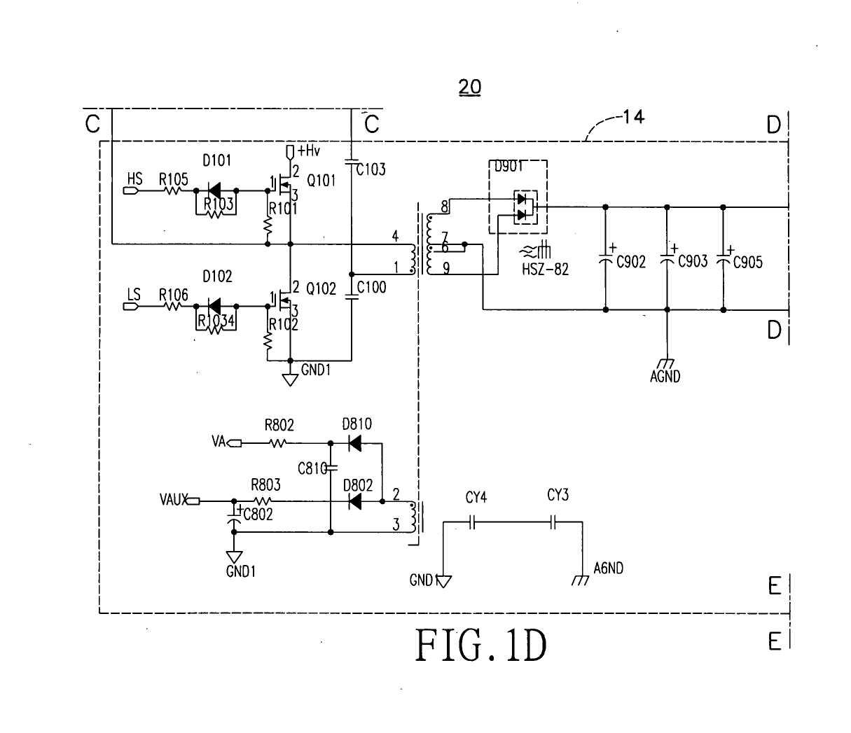

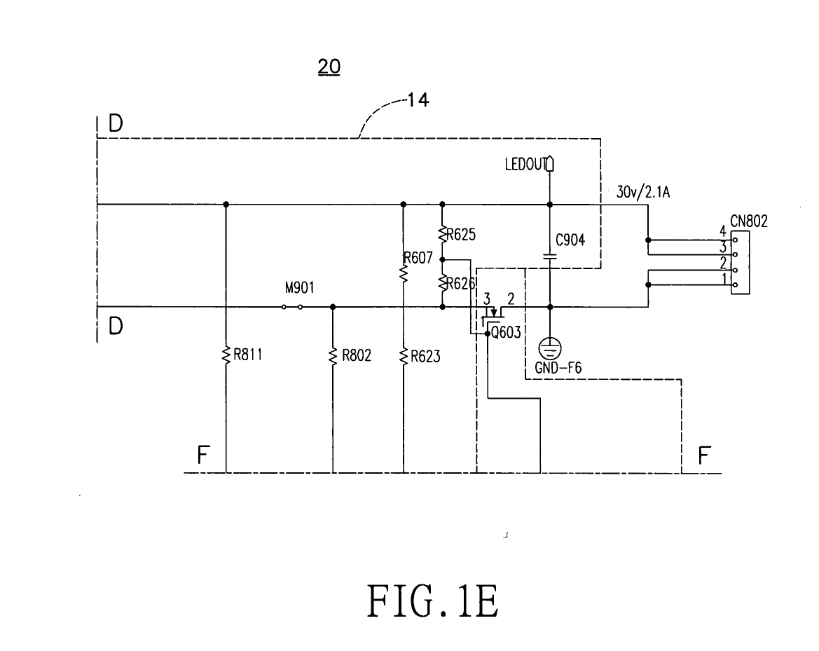

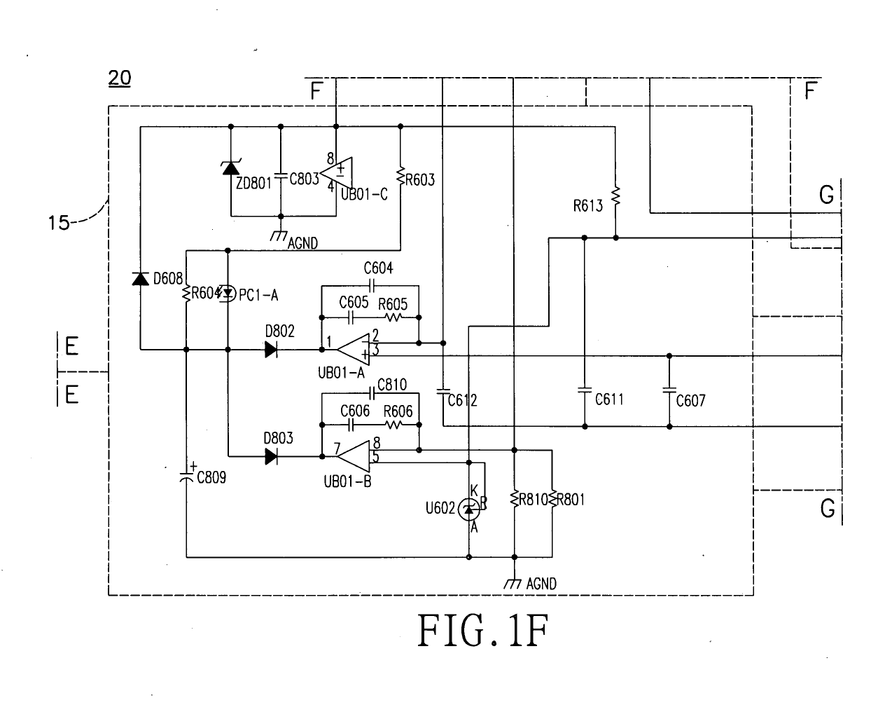

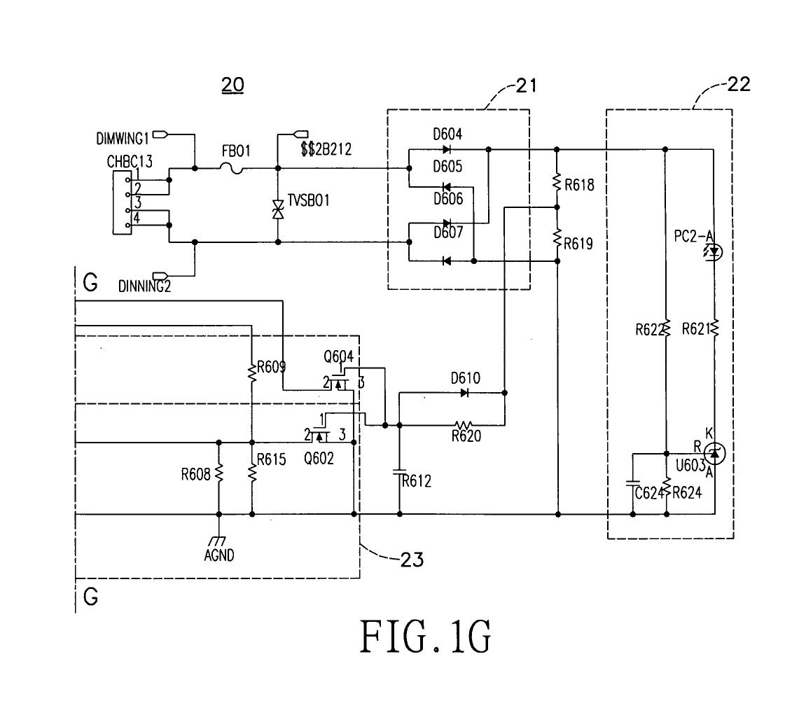

With reference to FIGS. 1A to 1G, a polarity-reversible dimming controller having function of switching light source has a power supply module 10 and a dimming control module 20. In the present embodiment, the power supply module 10 is a switching power supply device and has an EMI (Electromagnetic interference) filtering circuit 11, a PFC (Power Factor Calibration) circuit 12, a PWM controller 13 and a DC to DC converter 14. An input terminal of the EMI filtering circuit 11 is connected with an AC power source. The AC power is supplied to the power supply module 10, is filtered and rectified by the EMI filtering circuit 11, and is transmitted to the DC to DC converter 14 after the filtered AC power is further performed a power factor calibration through the PFC circuit 12. The DC to DC converter 14 has a transformer T1, an output terminal and a ground terminal. A primary side of the transformer T1 is connected with two power switches Q101 and Q103. The two power switches Q101 and Q102 are controlled by the PWM controller 13 to further switch on or off the primary side of the transformer T1. The PWM controller 13 has two output terminals HS and LS and a feedback terminal. The two output terminals HS and LS are further connected with the power switches Q101 and Q102. In the present embodiment, the power switches Q101 and Q102 are MOSFETs. The two output terminals HS and LS of the PWM controller 13 are respectively connected with gates of the power switches Q101 and Q102 to control a duty cycle of the primary side of the transformer T1 by pulse width modulation.

The power supply module 10 further has a constant current and constant voltage (CC and CV) circuit 15 connected between the output terminal of the DC to DC converter 14 and the feedback terminal of the PWM controller 13 to provide a feedback signal to the PWM controller 13 through the CC and CV circuit 15 so as to stably control luminance of the light source.

As the composition and operating theory of the power supply module 10 are roughly the same and are not the technical characteristics of the present invention, the technical content and operating theory of the power supply module 10 is not disclosed here in detail.

The dimming control module 20 has a full-wave rectifier 21, a switch control circuit 22, a dimming control circuit 23 and an output current switching circuit 24. In the present embodiment, the full-wave rectifier 21 is a full-wave bridge rectifier. The full-wave bridge rectifier has an input terminal and an output terminal. The output terminal of the full-wave bridge rectifier is connected with an external PWM dimmer (not shown). The output terminal is connected with the switch control circuit 22, the dimming control circuit 23 and the output current switching circuit 24.

The dimming control circuit 23 has a transistor Q602. The gate of the Q602 is connected to the output terminal of the full-wave rectifier 21 through a divider node between two divider resistors R618 and R619. The drain of the transistor 602 is connected to an input terminal of the CC and CV circuit 15 through the divider resistors R609 and R615. An output terminal of the CC and CV circuit 15 is connected with an input terminal PC1-A of an optical coupler. An output terminal PC1-B of the optical coupler is connected to the feedback terminal of the PWM controller 13. After a PWM signal inputted by the PWM dimmer is performed a full-wave rectification by the full-wave rectifier 21, the rectified PWM signal goes through the dimming control circuit 23, the CC and CV circuit 15, the optical coupler PC1 to vary the feedback signal of the PWM controller 13 for dimming the light source.

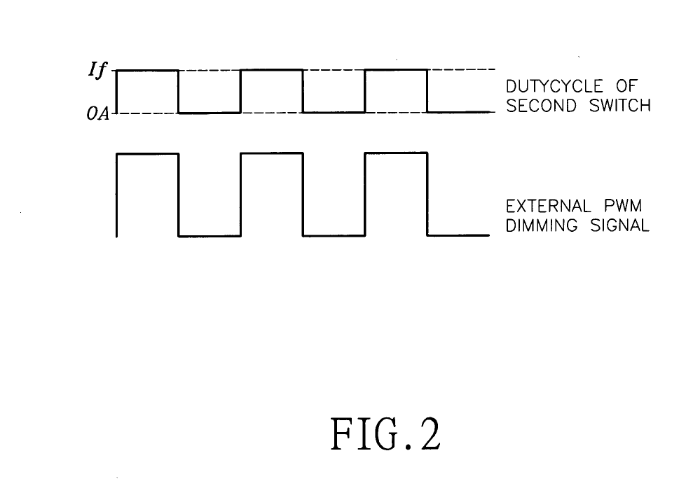

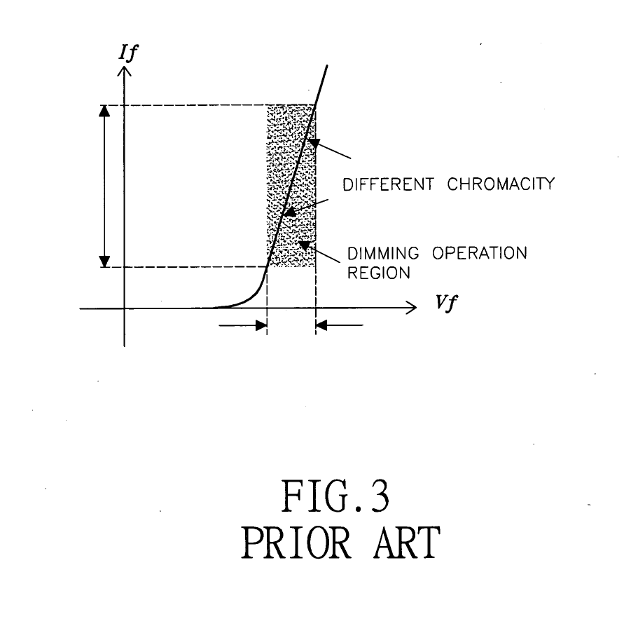

The output current switching circuit 24 has a first switch Q604 and a second switch Q603. In the present embodiment, the first and second switches are both MOSFETs. The gate of the first switch Q604 is connected with the output terminal of the full-wave rectifier 21 through the divider resistors R618 and R619. The drain of the first switch Q604 is connected to the gate of the second switch Q603. The drain and the source of the second switch Q603 are respectively and serially connected to the output terminal and the ground terminal of the DC to DC converter 14 so as to control a current outputted from the DC to DC converter 14 to the LED lamp. Specifically, a pulse width modulation is conducted on a forward current outputted from the DC to DC converter 14 to the LED lamp. With reference to FIG. 2, a duty cycle of the second switch Q603 is identical to that of an external PWM dimming signal. However, the second switch Q603 switches on or off under a constant forward current If. As far as using PWM control to dim LED lamps is concerned, the LED lamps have no concern about varying the chromacity of the LED lamps under the condition of constant forward current If.

The switch control circuit 22 has an adjustable regulator U603, a voltage divider circuit and an optical coupler. The voltage divider circuit has two divider resistors R622 and R624 and is connected to the output terminal of the full-wave rectifier 21. A divider node of the voltage divider circuit is connected to a reference terminal of the adjustable regulator U603. The adjustable regulator U603 is serially connected to the output terminal of the full-wave rectifier 21. An input terminal PC2-A of the optical coupler is connected to the output terminal of the full-wave rectifier 21. An output terminal PC2-B of the optical coupler is connected to the feedback terminal of the PWM controller 13. The adjustable regulator U603 is not turned on during a normal state. After the inputted PWM signal is sent to the adjustable regulator U603 through the full-wave rectifier 21 and the voltage divider circuit and exceeds a breakdown voltage of the adjustable regulator, the adjustable regulator U603 is turned on and sends out a signal through the optical coupler PC2 to turn off the PWM controller 13. The power supply module 10 is also shut down. The overall dimming controller enters a shutdown mode to prevent the dimming controller from wasting power during a standby condition.

The approach of mounting the full-wave rectifier 21 to an input terminal of the dimming control module 20 addresses an advantage facilitating assembling the dimming controller. This is because the full-wave rectifier 21 performs full-wave rectification to the inputted PWM signal. To the dimming controller itself, polarity match is not necessary to be considered upon assembling the dimming controller since reverse polarity upon assembling the dimming controller gives rise to no malfunction of the dimming controller.

In sum, the dimming controller of the present invention can dim the LED lamp without changing chromacity of the LED lamp, the dimming controller and the light source can be completely turned off by using an external PWM dimmer to save energy, and the dimming controller can be easily assembled by disregarding polarity match issue.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A polarity-reversible dimming controller having function of switching light source, comprising:
a power supply module adapted to connect with an AC power source and control a duty cycle of the AC power source to supply power and having:
an output terminal;
a ground terminal; and
a PWM controller having a feedback terminal;
a dimming control module controlling a signal and an output current of the feedback terminal of the PWM controller and having:
a full-wave rectifier having:
an input terminal; and
an output terminal connected to the output current switching circuit and the dimming control circuit;
an output current switching circuit having:
a first switch being a transistor and having a gate connected to the output terminal of the full-wave rectifier; and
a second switch being a transistor and having:
a gate connected to the drain of the first switch; and
a source connected to the ground terminal of the power supply module; and
a drain connected to the output terminal of the power supply module; and
a dimming control circuit connected with the feedback terminal of the PWM controller.

2. The polarity-reversible dimming controller as claimed in claim 1, wherein the dimming control module further has a switch control circuit having:
an adjustable regulator having a reference terminal;
a voltage divider circuit connected to the output terminal of the full-wave rectifier and having:
two divider resistors; and
a divider node located between the two divider resistors and connected to the reference terminal of the adjustable regulator; and
an optical coupler having:
an input terminal serially connected with the adjustable regulator and the output terminal of the full-wave rectifier; and
an output terminal connected to the feedback terminal of the PWM controller.

3. The polarity-reversible dimming controller as claimed in claim 2, wherein
the power supply module further has a constant current and constant voltage circuit connected between the output terminal of the power supply module and the feedback terminal of the PWM controller to provide a feedback signal to the PWM controller, and having an output terminal connected with the input terminal of the optical coupler and an input terminal;
the dimming control circuit has:
two divider resistors; and
a transistor having:
a gate connected to the output terminal of the full-wave rectifier; and
a drain connected to the input terminal of the constant current and constant voltage circuit through the two divider resistors.

4. The polarity-reversible dimming controller as claimed in claim 1, wherein the power supply module is a switching power supply device and further has:
an EMI filtering circuit having an output terminal and an input terminal adapted to connect to a AC power source;
a PFC circuit connected to the output terminal of the EMI filtering circuit and having an output terminal; and
a DC to DC converter connected the output terminal of the PFC circuit and having an output terminal, a ground terminal and a transformer having a primary side connected to at least one power switch;
the PWM controller further has at least one output terminal connected to the at least one power switch; and
the source and the drain of the second switch of the output current switching circuit are respectively and serially connected with the ground terminal and the output terminal of the DC to DC converter.

5. The polarity-reversible dimming controller as claimed in claim 2, wherein the power supply module is a switching power supply device and further has:
an EMI filtering circuit having an output terminal and an input terminal adapted to connect to a AC power source;
a PFC circuit connected to the output terminal of the EMI filtering circuit and having an output terminal; and
a DC to DC converter connected the output terminal of the PFC circuit and having an output terminal, a ground terminal and a transformer having a primary side connected to at least one power switch;
the PWM controller further has at least one output terminal connected to the at least one power switch; and
the source and the drain of the second switch of the output current switching circuit are respectively and serially connected with the ground terminal and the output terminal of the DC to DC converter.

6. The polarity-reversible dimming controller as claimed in claim 3, wherein the power supply module is a switching power supply device and further has:
an EMI filtering circuit having an output terminal and an input terminal adapted to connect to a AC power source;
a PFC circuit connected to the output terminal of the EMI filtering circuit and having an output terminal; and
a DC to DC converter connected the output terminal of the PFC circuit and having an output terminal, a ground terminal and a transformer having a primary side connected to at least one power switch;
the PWM controller further has at least one output terminal connected to the at least one power switch; and
the source and the drain of the second switch of the output current switching circuit are respectively and serially connected with the ground terminal and the output terminal of the DC to DC converter.
